(19) United States
(12) Patent Application Publication
(10) Pub. No.: US 2022/0382067 A1
(43) Pub. Date: Dec. 1, 2022

(54) APPARATUS AND METHOD FOR A DISPLAY SCREEN AND AN OPTICAL LIGHT EMITTER

(71) Applicants: STMicroelectronics (Alps) SAS, Grenoble (FR); STMicroelectronics (Grenoble 2) SAS, Grenoble (FR); STMicroelectronics (Research & Development) Limited, Marlow (GB)

(72) Inventors: Quentin Mermillod-Anselme, Grenoble (FR); Salim Bouchene, Seyssinet-Pariset (FR); Adam Caley, Fife (GB)

(21) Appl. No.: 17/661,381

(22) Filed: Apr. 29, 2022

(30) Foreign Application Priority Data
May 31, 2021 (FR) 2105715

(51) Int. Cl. G02B 27/28; G01C 3/08; G02B 5/30

(52) U.S. Cl. CPC G02B 27/281; G01C 3/08; G02B 5/3058

(57) ABSTRACT

The present disclosure relates to an assembly for an electronic device comprising: a display screen; an optical light emitter adapted to emit an Infrared or near Infrared light beam through the display screen; the optical light emitter and the display screen being of the type that, when an unpolarized light beam from the optical light emitter passes through a region of the display screen, a white spot of a first intensity is formed in the region; a light polarizer positioned between the optical light emitter and the display screen, the light polarizer being orientated such that a white spot of a second intensity, lower than the first intensity, is formed when the light beam, from the optical light emitter and polarized by the light polarizer, passes through the region of the display screen.

### CROSS-REFERENCE TO RELATED APPLICATIONS

This application claims the benefit of French Patent Application No. 2105715, filed on May 31, 2021, which application is hereby incorporated herein by reference.

### TECHNICAL FIELD

The present disclosure relates generally to electronic devices and methods, and, more particularly, to electronic devices and methods for a display screen and an optical light emitter.

### BACKGROUND

Electronic devices such as mobile phones, e.g. smartphones, tablet computers, smartwatches, touchpads, laptop computers comprising a screen displaying information and/or images destined for a user, for example a user of the device, are known.

Electronics devices comprising an optical device such as an optical light emitter, and possibly an optical sensor, disposed under the display screen are also known. The optical device may comprise a proximity sensor or an ambient light sensor (ALS).

A proximity sensor generally comprises an optical light emitter and an optical sensor (which may be also referenced as a “proximity detector”). The general principle of a proximity sensor is that the light emitter emits a light beam which is reflected from an object and picked up by the proximity detector. The optical sensor may also be provided with other circuitry provided as part of the sensor or associated therewith, which analyzes the output from the sensor for a proximity sensing calculation. The proximity sensor may be a time-of-flight (ToF) sensor type.

The optical light emitter may comprise a light emitting diode (LED) or a vertical cavity surface emitting laser (VCSEL).

For instance, TOF sensors generally comprise a VCSEL for emitting light radiation, and an array of Single Photon Avalanche Detectors (SPADs) for detecting the reflected light beam from the object.

The display screen may be an organic light-emitting diode (OLED) type screen.

Some proximity sensors use IR (infrared) or NIR (Near Infra Red) light (e.g., at 940 nm). More generally, some optical light emitters are configured to emit IR or NIR light. For compatibility reasons, silicon-based proximity sensors generally use NIR light.

For certain applications, it is desired to mount an optical light emitter on the same side of an electronics device as the display screen. In some cases, the optical light emitter can be positioned within a bezel, which is a non-display area in a border region reserved for such devices. However, in order to increase the area of the display screen, it has been proposed to dispense with such a bezel, and instead to place the optical light emitter behind the display screen, such that it transmits light through the display screen.

Regrettably, the unwanted appearance of a “white” spot over an activated OLED display screen has been observed when the optical light emitter transmits light through the OLED display screen. This spot is referred as a “white” spot although it may appear to have another color, such as grey, depending on the color being displayed by the display screen and on the emitted light characteristics. The white spot is visible by the user of the electronic device.

While the problem of the white spot has been the subject of extensive research, existing solutions have been found to be of limited effectiveness, or to add undesirable constraints and/or cost.

### SUMMARY

There is a need for an assembly for an electronic device, comprising at least a display screen and an optical light emitter underneath the display screen, capable of reducing the white spot intensity, or even suppressing the white spot. In particular, it would be desirable that the solution does not reduce the intensity of the light emitted by the optical light emitter. It would also be desirable that the solution is easy to implement.

One embodiment addresses all or some of the drawbacks of known electronic devices.

In one embodiment, an assembly for an electronic device comprises a display screen, an optical light emitter adapted to emit an Infrared or near Infrared light beam through the display screen, the optical light emitter and the display screen being of the type that, when an unpolarized light beam from the optical light emitter passes through a region of the display screen, a white spot of a first intensity is formed in the region, and a light polarizer positioned between the optical light emitter and the display screen, the light polarizer being orientated such that a white spot of a second intensity, lower than the first intensity, is formed when the light beam, from the optical light emitter and polarized by the light polarizer, passes through the region of the display screen.

According to one embodiment, the light polarizer is separate from the optical light emitter. In an alternative embodiment, the light polarizer is integrated in the optical light emitter such that the light polarizer faces the display screen.

In one embodiment, the light polarizer comprises a polarizing film. In another embodiment, the light polarizer comprises a polarizing grid.

In one embodiment, the display screen is an organic light-emitting diode (OLED) display screen.

In one embodiment, the optical light emitter comprises a vertical cavity surface emitting laser (VCSEL).

In one particular embodiment, the display screen integrates a display polarizer orientated according to a first angle, and the light polarizer is orientated according to a second angle, the second angle being equal to the first angle minus forty-five degrees in the trigonometric direction.

In one embodiment, the light polarizer comprises a linear polarizer. In a particular embodiment, the linear polarizer is adapted to form a horizontally polarized light beam.

In another embodiment, the light polarizer is adapted to form a circularly polarized light beam. In a particular embodiment, the linear polarizer is adapted to form a right-handed polarized light beam.

In one embodiment, an electronic device comprises the assembly according to one embodiment.

In one embodiment, the electronic device further comprises a proximity detector, the optical light emitter and the proximity detector being included in a proximity sensor.

In one embodiment, the optical light emitter and the proximity detector are housed within an optical package.

In one embodiment, the light polarizer is integrated within the optical package. In an alternative embodiment, the light polarizer is positioned between the optical package and the display screen.

In one embodiment, a method comprises providing a display screen, providing an optical light emitter adapted to emit an Infrared (IR) or near Infrared light (NIR) beam through the display screen, the optical light emitter and the display screen being of the type that, when an unpolarized light beam from the optical light emitter passes through a region of the display screen, a white spot of a first intensity is formed in the region, positioning a light polarizer between the optical light emitter and the display screen, and orienting the light polarizer such that a white spot of a second intensity, lower than the first intensity, is formed when the light beam, from the optical light emitter and polarized by the light polarizer, passes through the region of the display screen.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates a trigonometric circle;

FIG. 2 schematically illustrates an embodiment of an assembly for an electronic device;

FIG. 3 schematically illustrates another embodiment of an assembly for an electronic device;

FIG. 4 illustrates in details an example of an optical light emitter as shown in FIG. 3;

FIG. 5 illustrates an embodiment of an electronic device comprising an assembly according to an embodiment;

FIG. 6 illustrates another embodiment of an electronic device comprising an assembly according to an embodiment;

FIG. 7 illustrates the results of first experimental tests;

FIG. 8 illustrates the results of second experimental tests;

FIG. 9 illustrates the results of third experimental tests;

FIG. 10 illustrates the results of fourth experimental tests; and

FIG. 11 illustrates the results of fifth experimental tests.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the other components of an assembly or an electronic device integrating a display screen and an optical light emitter have not been detailed, the described embodiments being compatible with the usual other components of assemblies or electronic devices comprising a display screen.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

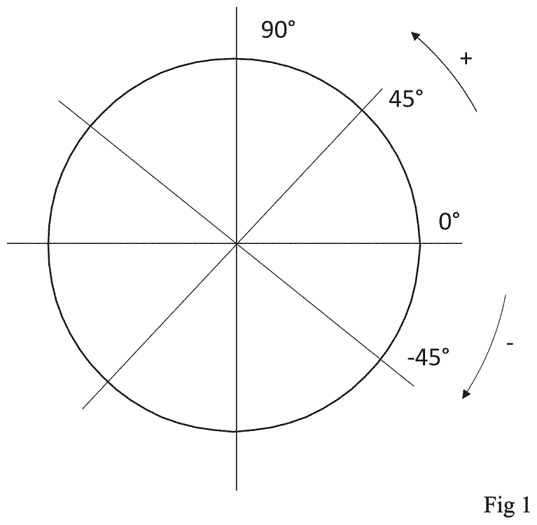

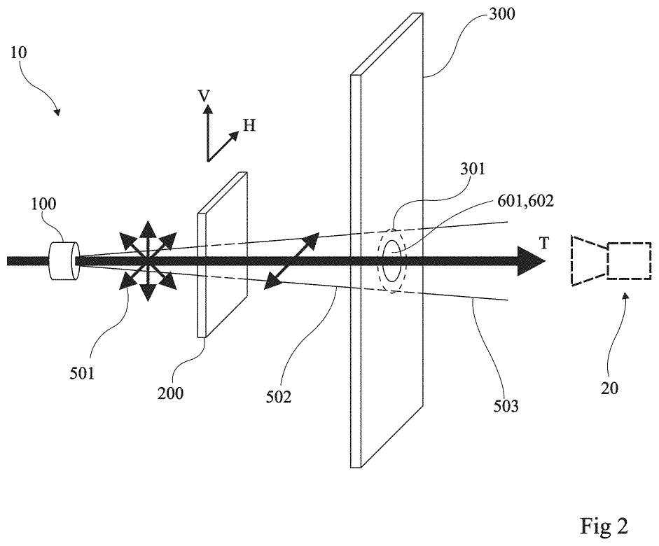

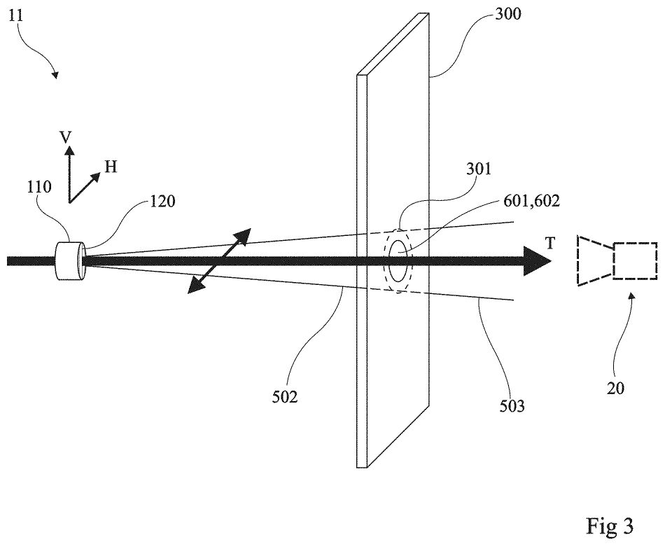

Referring to an electronic device such as a mobile phone, a tablet computer, a smartwatch, a touchpad, more generally to an electronic device having a substantially rectangular shape, the horizontal orientation (0° in the trigonometric circle illustrated in FIG. 1 and direction “H” in FIGS. 2 and 3) corresponds for example to the minor axis of the electronic device, while the vertical orientation (90° in the trigonometric circle illustrated in FIG. 1 and direction “V” in FIGS. 2 and 3) corresponds for example to the major axis.

In addition, the terms “under” or “underneath” and “over” refer to the light propagation direction, that is, from the optical light emitter to the display screen (direction materialized by a thick horizontal arrow referenced “T” in FIGS. 2 to 6). The terms “under” or “underneath” mean before the display screen in the light propagation direction, and “over” means after the display screen in the light propagation direction.

Unless specified otherwise, the expressions “around”, “approximately”, “substantially” and “in the order of” signify within 10%, and preferably within 5%.

FIG. 1 illustrates a trigonometric circle which is used as a reference for the orientation directions. The trigonometric direction corresponds to the “+” direction. The clockwise direction corresponds to the “−” direction. The anti-clockwise direction corresponds to the “+” direction. 0° corresponds to the horizontal direction and 90° corresponds to the vertical direction. In all the embodiments, the orientation is given from the point of view of the emitter, in the light propagation direction.

In FIGS. 2 and 3, for the understanding of the embodiments, the elements have been shown in exploded 3D view.

FIG. 2 schematically illustrates an embodiment of an assembly 10 comprising a display screen 300, an optical light emitter 100 under the display screen and a light polarizer 200 between the display screen and the optical light emitter. The optical light emitter 100 is adapted to emit an unpolarized Infrared or near Infrared light beam, for instance with a light wavelength in the range 900-1000 nm. In some embodiments, the optical light emitter 100 is adapted to emit a Near Infrared light (NIR) beam with a light wavelength around 940 nm.

The optical light emitter 100 and the display screen 300 are of the type that, when an unpolarized light beam 501 from the optical light emitter passes through a region 301 of the display screen, a white spot 601 of a first intensity is formed in the region. The light polarizer 200 is orientated such that a white spot 602 of a second intensity, lower than the first intensity, is formed when the light beam 502, from the optical light emitter 100 and polarized by the light polarizer 200, passes through the region 301 of the display screen.

In the embodiment illustrated in FIG. 2, the light polarizer 200 is separate from the optical light emitter 100 and is a polarizing film. In addition, the illustrated polarizing film is a linear polarizing film, and is orientated in the horizontal direction, that is, is adapted to form a horizontally polarized light beam; in other words, it only allows the horizontal component of the electric field of the light beam to pass through.

An advantage of this embodiment is its flexibility.

Non-limitative examples of polarizing film types may include a diffuse Reflective Film Polarizer, a Giant Birefringent Optical (GBO) multilayer reflective polarizer, a laminated Polymer Film Linear Polarizer, and a wire grid polarizing film.

In an alternative embodiment, the linear light polarizer 200 may be orientated in the vertical direction, that is, adapted to form a vertically polarized light beam, or according to another orientation. The proper orientation may be for example determined by measuring a decreasing of the white spot intensity, or even by the suppression of the white spot, when turning the linear light polarizer 200 in a trigonometric or clockwise direction in a plane perpendicular to the light propagation direction T.

In a yet alternative embodiment, the light polarizer may be a circular polarizer, that is, adapted to form a circularly polarized light beam. The circular polarizer may be orientated in the right direction, that is, adapted to form a right-handed polarized light beam, or the circular polarizer may be orientated in the left direction, that is, adapted to form a left-handed polarized light beam. More generally, the proper orientation is determined by the decreasing of the white spot intensity, or even by the suppression of the white spot, when turning the circular light polarizer in a trigonometric or clockwise direction in a plane perpendicular to the light propagation direction T.

In some embodiments, the display screen may include its own polarizer(s) (referred as “display” polarizer(s)), for instance anti-reflection polarizers. In such a case, the selection of the light polarizer type and the orientation of the selected light polarizer 200 may be adapted to the display polarizer(s) within the display screen.

In some embodiments, the display screen 300 is an organic light-emitting diode (OLED) type screen. Some OLED screens comprise a quarter-wave plate and a linear polarizer inside the OLED stack to remove unwanted reflection of ambient light. In such a case, the light polarizer 100 may have an orientation equal to the linear polarizer of the screen minus forty-five degrees.

FIG. 3 schematically illustrates another embodiment of an assembly 11 comprising a display screen 300, and an optical light emitter 110 under the display screen. The embodiment of FIG. 3 differs from that of FIG. 2 in that the light polarizer 200 is no longer present, and instead the optical light emitter 110 integrates a light polarizer 120.

The other features and embodiments described above for the assembly of FIG. 2 may also be applied to the assembly of FIG. 3.

In the embodiment illustrated in FIG. 3, the light polarizer 120 is for example a polarizing grid.

As for the assembly of FIG. 2, the optical light emitter 110 and the display screen 300 of FIG. 3 are of the type that, when an unpolarized light beam 501 from the optical light emitter passes through a region 301 of the display screen, a white spot 601 of a first intensity is formed in the region. The polarizer grid 120 is orientated such that a white spot 602 of a second intensity, lower than the first intensity, is formed when the light beam 502, from the optical light emitter and polarized by the polarizer grid, passes through the region 301 of the display screen.

An advantage of this embodiment is that the emission power of the optical light emitter 110 is calibrated at the output of the polarizer 120, which is part of the optical light emitter. The emission power is therefore calibrated by integrating the power loss due to the polarizer (the calibrated emission power is generally limited by a regulatory limit).

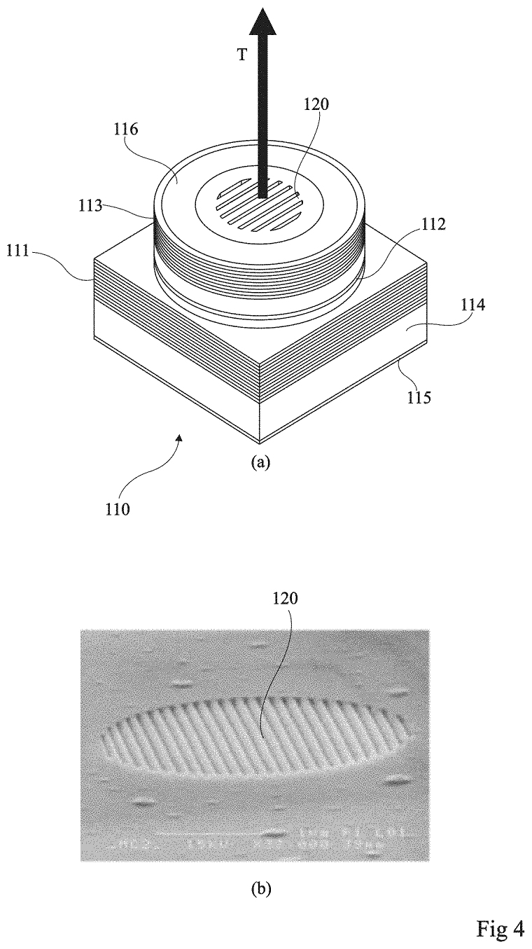

FIG. 4 illustrates in detail an example of an optical light emitter 110 integrating a polarizing grid 120 as shown in FIG. 3.

The optical light emitter illustrated in FIG. 4 is a VCSEL. The VCSEL comprises a first (or “bottom”) mirror 11 and a second (or “top”) mirror 113, on either side of active layer 112. The first and second mirrors 111, 113 may comprise structures with multiple layers, such as Distributed Bragg Reflectors (DBR). The active layer 112 may comprise quantum wells. The mirrors and the active layer are mounted on a substrate 114. The VCSEL comprises a bottom electrical contact 115 and a top electrical contact 116. A polarizing grid 120 is mounted on the top of the VCSEL. The polarizing grid 120 may consist of fine parallel metallic wires placed in a plane.

The polarizing film of FIG. 2 may be replaced by a polarizing grid. The polarizing grid of FIG. 3 may be replaced by a polarizing film.

In order to calibrate the orientation of the light polarizer, the measurement of the white spot intensity may be carried out by a light sensor 20 placed in front of the display screen 300, as illustrated in FIGS. 2 and 3 (the light sensor is illustrated in dotted lines since it is not part of the assembly). It will be understood that any type of light sensor may be used to measure the white spot intensity, such as a photometer.

According to an embodiment, a method for fabricating an assembly 10 comprises providing a display screen 300, providing an optical light emitter 100 adapted to emit an Infrared or near Infrared light beam 501 through the display screen, the optical light emitter and the display screen being of the type that, when an unpolarized light beam from the optical light emitter passes through a region 301 of the display screen, a white spot 601 of a first intensity is formed in the region, positioning a light polarizer 200 between the optical light emitter 100 and the display screen 300, orienting the light polarizer 200 to a first orientation, measuring the white spot intensity corresponding to the first orientation, using the light sensor 20, and, if the measured intensity of the white spot is lower than the first intensity, then maintaining the light polarizer 200 at the first orientation, and, if the measured intensity of the white spot is higher than the first intensity, then orienting the light polarizer at least to another orientation different than the first orientation and repeating the same operations as for the first orientation until the measured intensity of the white spot is lower than the first intensity, or even until the light sensor 20 does not detect an intensity anymore.

According to another embodiment, a method for fabricating an assembly 11 comprises providing a display screen 300, providing an optical light emitter 110 adapted to emit an Infrared or near Infrared light beam 501 through the display screen; the optical light emitter integrating a light polarizer 120, the optical light emitter and the display screen being of the type that, when an unpolarized light beam from the optical light emitter passes through a region 301 of the display screen, a white spot 601 of a first intensity is formed in the region, positioning the optical light emitter 110 such that the light polarizer 120 faces the display screen 300, orienting the light polarizer 120 or the optical light emitter 110 to a first orientation, measuring the white spot intensity corresponding to the first orientation, using the light sensor 20, and, if the measured intensity of the white spot is lower than the first intensity, maintaining the light polarizer 120 or the optical light emitter 110 at the first orientation, and, if the measured intensity of the white spot is higher than the first intensity, orienting the light polarizer 120 or the optical light emitter 110 to at least another orientation different than the first orientation and repeating the same operations as for the first orientation until the measured intensity of the white spot is lower than the first intensity, or even until the light sensor 20 does not detect an intensity anymore.

Alternatively, the light polarizer may be maintained at an orientation only if the measured intensity of the white spot is lower than a threshold intensity, lower than the first intensity.

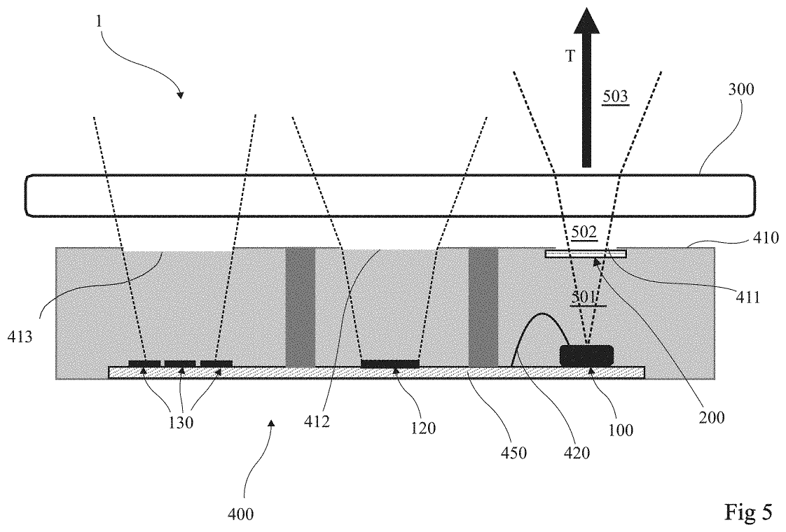

FIG. 5 illustrates an embodiment of an electronic device 1 integrating an assembly like that of FIG. 2.

The illustrated electronic device 1 comprises a proximity detector 120 and an optical light emitter 100 forming a proximity sensor, and an ambient light sensor 130, all those sensors being housed within an optical package 400.

The proximity detector 120 may be of any type of suitable optical detector. For example, the proximity detector may include a single light sensitive pixel comprising a photodiode or a plurality of light sensitive pixels, each pixel comprising a photodiode. The proximity detector may include, or may be, a single photon avalanche detector (SPAD).

The optical light emitter 100 may be a VCSEL, like the one described in FIG. 4, but without the polarizing grid. It will be understood that any type of optical light emitter may be used.

The ambient light sensor 130 illustrated in FIG. 5 comprises three ambient light photodetectors, configured to detect the intensity of the ambient light at three different wavelengths, that is for three different colors. For example, the ambient light sensor is configured to detect the luminosity at wavelengths corresponding to RGB (red-green-blue) colors. Such type of sensor is well-known and therefore not discussed in detail. It will be understood that any type of ambient light sensors may be used.

The optical package 400 for example includes in its lower part a substrate 450 on which the optical light emitter 100, the proximity detector 120 and the ambient light sensor 130 are assembled. The optical light emitter 100 is for example electrically connected to the substrate 450 via bond wires 420 also housed within the optical package.

The optical package 400 also for example comprises a cover member 410 covering the optical light emitter 100, and also for example covering the proximity detector 120 and the ambient light sensor 130. For example, the cover member 410 comprises portions 411, 412, 413 transparent to emitted and/or received light. These transparent portions are therefore suitably placed, respectively, in front the optical light emitter 100, the proximity detector 120 and the ambient light sensor 130. The transparent portions may be apertures formed through the cover member or may be transparent portions of the cover. The VCSEL structure emits a light beam 501 when activated, generally randomly polarized.

The electronic device 1 further includes a display screen 300, which may be an OLED type screen. The optical package 400 is positioned under the display screen 300.

A light polarizer 200 is placed within the optical package and attached to the cover member 410. The light polarizer 200 is dimensioned and positioned to cover the transparent portion 411, which faces the optical light emitter 100. The light beam 501 traverses the light polarizer 200 and forms a polarized light beam 502.

The light polarizer 200 may include, or may be, a polarizing film such as one of those described with reference to FIG. 2.

Alternately, the light polarizer 200 may include, or may be, a polarizing grid, which may consist of fine parallel metallic wires placed in a plane.

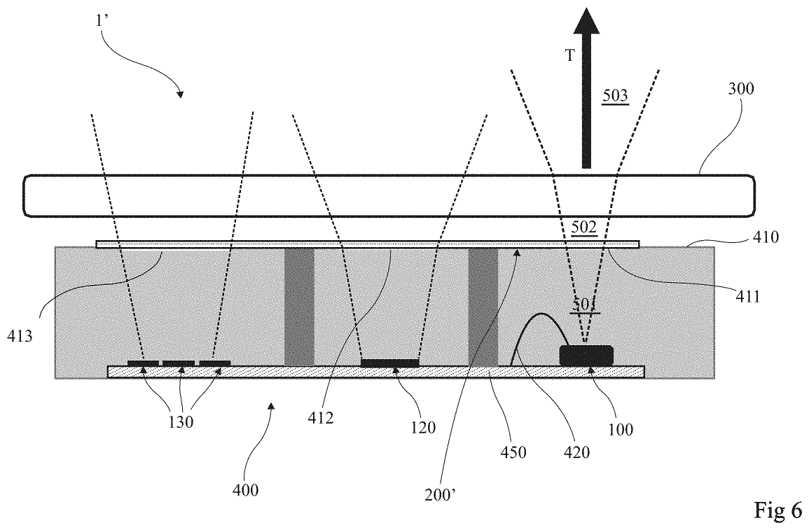

FIG. 6 illustrates another embodiment of an electronic device 1′ integrating an assembly like that of FIG. 2. The electronic device of FIG. 6 differs from that of FIG. 5 in that the polarizer 200 is replaced by a polarizer 200′ extending along the length of the optical package. The polarizer 200′ is positioned on the optical package (between the optical package 400 and the display screen 300) instead of being positioned within the optical package. In addition, the light polarizer 200′ is for example large enough to cover all the transparent portions 411, 412, 413 of the optical package 400. The other features and embodiments described above relative to the electronic device of FIG. 5 may also be applied to the electronic device of FIG. 6.

Alternately, the light polarizer may be positioned within the optical package, attached to the cover member of the optical package and dimensioned to cover all the transparent portions 411, 412, 413 of the optical package 400.

Alternately, the light polarizer may be positioned on the optical package 400, dimensioned and positioned to cover the transparent portion 411 of the optical package which faces the optical light emitter 100.

The optical package 400 further includes common circuitry (not shown in FIGS. 5 and 6).

In another embodiment, the ambient light sensor 130 may be omitted in the electronic device of FIG. 5 or FIG. 6.

The display screen 300, for example, an OLED type screen, may be integrated in an electronic device such as a mobile phone (e.g., a smartphone), a tablet computer, a smartwatch, a touch pad, a laptop computer ( . . . ), by being placed on an electronic board supporting the electronic components of the electronic device, the optical light emitter, the light polarizer, and possibly the optical sensor or detector, being positioned between the electronic board and the display screen.

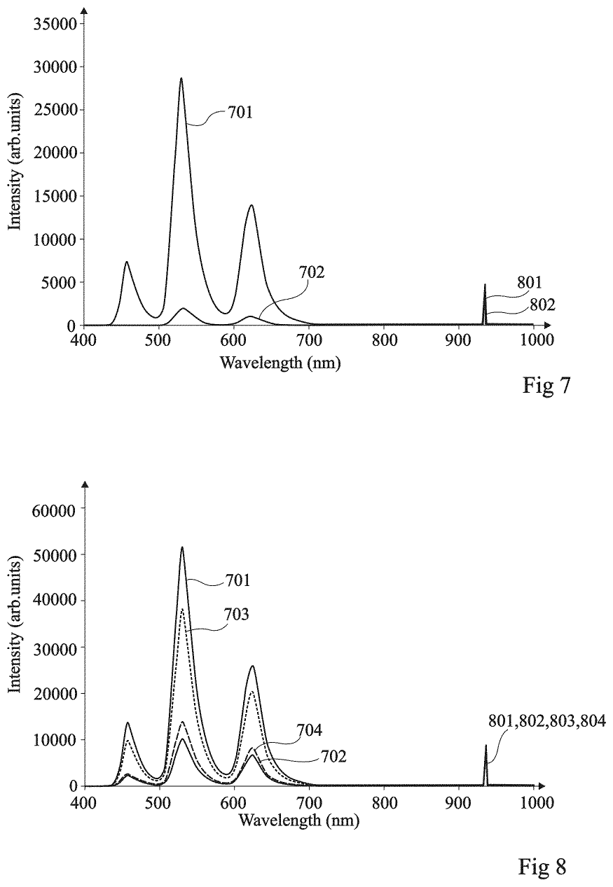

FIGS. 7 to 11 illustrate the results of experimental tests obtained for different types of smartphones and different colors of OLED type screens. The tested smartphones include a VCSEL optical light emitter under the OLED screen and different light polarizers placed between the screen and the emitter. In these experimental tests, the VCSEL emitter emits a NIR light (940 nm) towards the OLED screen. In the experimental tests of FIGS. 7 to 11, the wavelength peak of the VCSEL was attenuated to avoid saturating the light sensor used to measure the intensity of the white spots to generate the curves.

In all the illustrated graphics, the x-axis corresponds to the wavelength of the light and the y-axis corresponds to the intensity of the light, curves 701 correspond to the intensity of the “white” spot (in the visible wavelengths) using a vertically orientated polarizer, curves 702 correspond to the intensity of the “white” spot (in the visible wavelengths) using a horizontally orientated polarizer and curves 801 and 802 are the corresponding intensities of the VCSEL.

FIG. 7 shows the results of first experimental tests performed on a LG smartphone (white screen). The letters “LG” may correspond to one or more registered trademarks.

It is apparent that the horizontally orientated polarizer has a significant effect on decreasing the intensity of all the white spot peaks, and that none of the polarizers have any impact on the intensity of the light emitted by the VCSEL.

FIG. 8 shows the results of second experimental tests performed on an LG smartphone (white screen). Circular polarizers were tested in addition to linear polarizers. Curve 703 corresponds to the intensity of the “white” spot (in the visible wavelengths) using a left orientated circular polarizer, and curve 704 corresponds to the intensity of the “white” spot (in the visible wavelengths) using a right orientated circular polarizer. Curves 803 and 804 are the corresponding intensities of the VCSEL.

It is apparent that the horizontally orientated polarizer and the right orientated circular polarizer have a significant effect on decreasing the intensity of all the white spot peaks, and that none of the polarizers have any impact on the intensity of the light emitted by the VCSEL.

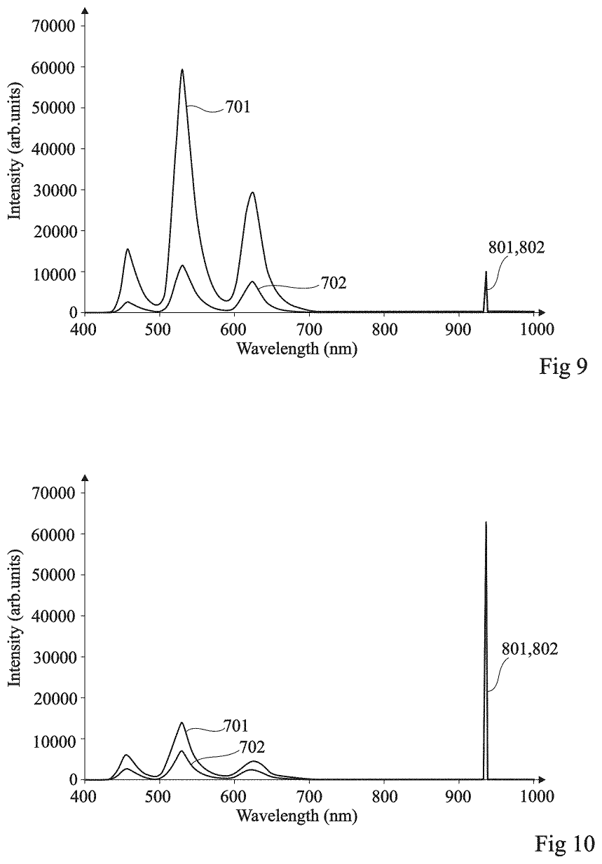

FIG. 9 shows the results of third experimental tests performed on an LG smartphone (black screen).

It is apparent that the horizontally orientated polarizer has a significant effect on decreasing the intensity of all the white spot peaks, that none of the polarizers have any impact on the intensity of the light emitted by the VCSEL, and that the color of the screen does not have any impact on the efficiency of the polarizer, when comparing to the results of FIGS. 7 and 8.

FIG. 10 shows the results of fourth experimental tests performed on a Xiaomi smartphone (white screen). The name “Xiaomi” may correspond to one or more registered trademarks.

It is apparent that the horizontally orientated polarizer has an effect on decreasing the intensity of all the white spot peaks, and that none of the polarizers have any impact on the intensity of the light emitted by the VCSEL.

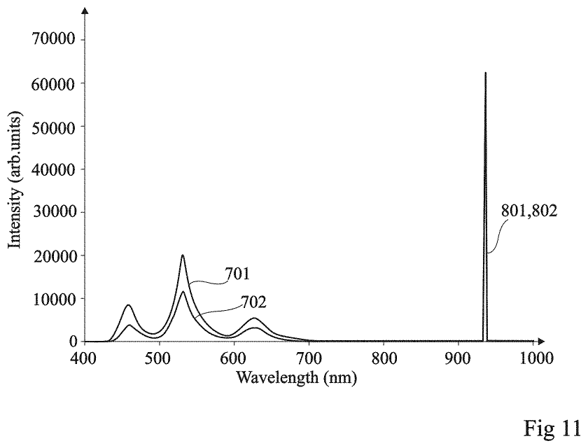

FIG. 11 shows the results of fifth experimental tests performed on a Xiaomi smartphone (black screen).

It is also apparent that the horizontally orientated polarizer has an effect on decreasing the intensity of all the white spot peaks, that none of the polarizers have any impact on the intensity of the light emitted by the VCSEL, and that the color of the screen does not have any impact on the efficiency of the polarizer, when comparing to the results of FIG. 10.

Thus, the solution makes use of a light polarizer, which is properly configured and orientated to filter the light coming from the “white” spot.

It is apparent from the description that the solution is compact, easy integrable, low cost, and passive (no power consumption, no software needed).

In addition, the experimental results show that the solution does not reduce the power of the transmitted light from the optical light emitter through the display screen.

Various embodiments and variants have been described. Those skilled in the art will understand that certain features of these embodiments can be combined and other variants will readily occur to those skilled in the art. In particular, the disclosure is not restricted to any particular type of optical light emitter. Although some embodiments mentioned above refer to a VCSEL light emitter, it is to be appreciated that a LED emitter or other suitable light emitter may alternatively be applied.

Finally, the practical implementation of the embodiments and variants described herein is within the capabilities of those skilled in the art based on the functional description provided hereinabove.

What is claimed is:

1. An assembly for an electronic device, the assembly comprising:
a display screen;
an optical light emitter configured to emit an infrared or near infrared light beam through the display screen; and
a light polarizer positioned between the optical light emitter and the display screen, wherein the light polarizer is orientated such that a first white spot of a first intensity is formed in a region of the display screen in response to the light beam, from the optical light emitter and polarized by the light polarizer, passing through the region of the display screen, and wherein the first intensity is less than a second intensity of a second white spot that would be formed in the region in response to an unpolarized light beam from the optical light emitter passing through the region.

2. The assembly according to claim 1, wherein the light polarizer is separate from the optical light emitter.

3. The assembly according to claim 1, wherein the light polarizer is integrated in the optical light emitter and oriented to face the display screen.

4. The assembly according to claim 1, wherein the light polarizer comprises a polarizing film.

5. The assembly according to claim 1, wherein the light polarizer comprises a polarizing grid.

6. The assembly according to claim 1, wherein the display screen is an organic light-emitting diode screen.

7. The assembly according to claim 1, wherein the optical light emitter comprises a vertical cavity surface emitting laser.

8. The assembly according to claim 1, wherein the display screen integrates a display polarizer orientated according to a first angle, wherein the light polarizer is orientated according to a second angle, and wherein the second angle is equal to the first angle minus forty-five degrees in a trigonometric direction.

9. The assembly according to claim 1, wherein the light polarizer comprises a linear polarizer.

10. The assembly according to claim 9, wherein the linear polarizer is configured to generate a horizontally polarized light beam.

11. The assembly according to claim 1, wherein the light polarizer is configured to generate a circularly polarized light beam.

12. The assembly according to claim 11, wherein the light polarizer is configured to generate a right-handed polarized light beam.

13. An electronic device comprising:
a display screen;
an optical light emitter configured to emit an infrared or near infrared light beam through the display screen;
a proximity detector configured to receive a reflection of the light beam reflected off an object and passed back through the display screen; and
a light polarizer positioned between the optical light emitter and the display screen, wherein the light polarizer is orientated such that a first white spot of a first intensity is formed in a region of the display screen in response to the light beam, from the optical light emitter and polarized by the light polarizer, passing through the region of the display screen, and wherein the first intensity is less than a second intensity of a second white spot that would be formed in the region in response to an unpolarized light beam from the optical light emitter passing through the region.

14. The electronic device according to claim 13, wherein the optical light emitter and the proximity detector are included in a proximity sensor.

15. The electronic device according to claim 14, wherein the optical light emitter and the proximity detector are housed within an optical package.

16. The electronic device according to claim 15, wherein the light polarizer is integrated within the optical package.

17. The electronic device according to claim 15, wherein the light polarizer is positioned between the optical package and the display screen.

18. A method comprising:
positioning an optical light emitter behind a display screen, the optical light emitter configured to emit an infrared or near infrared light beam through the display screen;
positioning a light polarizer between the optical light emitter and the display screen; and
orienting the light polarizer such that a first white spot of a first intensity is formed in a region of the display screen in response to the light beam, from the optical light emitter and polarized by the light polarizer, passing through the region of the display screen, and wherein the first intensity is less than a second intensity of a second white spot that would be formed in the region in response to an unpolarized light beam from the optical light emitter passing through the region.

19. The method of claim 18, wherein orienting the light polarizer further comprises:
positioning a light sensor in front of the display screen, the light sensor configured to receive the light beam emitted by the optical light emitter and passed through the display screen;
orienting the light polarizer to a first orientation;
measuring, by the light sensor, a first light beam intensity corresponding to the first orientation;
orienting the light polarizer to a second orientation;
measuring, by the light sensor, a second light beam intensity corresponding to the second orientation;
comparing the first and second light beam intensities; and
selecting a selected orientation of the light polarizer according to a lower light beam intensity of the first and second light beam intensities.

20. The method of claim 19, further comprising repeating the orienting, measuring, comparing, and selecting steps for additional orientations of the light polarizer until selecting a final orientation of the light polarizer at which the light sensor does not detect any light beam intensity.
